(19) United States
(12) Patent Application Publication
(10) Pub. No.: US 2026/0249459 A1
(43) Pub. Date: Aug. 27, 2026

(54) METHOD, CONTROL MODULE, AND ROBOT SYSTEM FOR DETECTING WHETHER ROBOT HAS COMPLETED TASK BY CONSIDERING CONTEXT

(71) Applicant: ELECTRONICS AND TELECOMMUNICATIONS RESEARCH INSTITUTE, Daejeon (KR)

(72) Inventor: Byung-Ok HAN, Daejeon (KR)

(21) Appl. No.: 19/382,922

(22) Filed: Nov. 7, 2025

(30) Foreign Application Priority Data
Feb. 25, 2025 (KR) 10-2025-0024175

(51) Int. Cl. B25J 9/16; B25J 13/08; B25J 19/02

(52) U.S. Cl. CPC B25J 9/1661; B25J 9/1605; B25J 9/1697; B25J 13/08; B25J 19/023

(57) ABSTRACT

Disclosed herein are a method, control module, and robot system for detecting whether a robot has completed a task by considering context. The control module may include storage configured to store a goal related to the execution of a robot task and a controller configured to receive observation information related to the execution of the robot task, generate a prompt based on the goal and the received observation information, generate a task completion detection (TCD) function based on the generated prompt, and identify whether the execution of the robot task is successful by using the generated TCD function.

### CROSS REFERENCE TO RELATED APPLICATION

This application claims the benefit of Korean Patent Applications No. 10-2025-0024175, filed on February 25, 2025, which is hereby incorporated by reference in its entireties into this application.

### BACKGROUND OF THE INVENTION

### Technical Field

The present disclosure relates generally to a method, control module, and robot system for detecting whether a robot has completed a task by considering context, and more particularly to a method, control module, and robot system for detecting whether a robot has completed a task by considering context, which detect whether a robot has completed a given task by considering context when performing the given task. The method, control module, and robot system may be used in a robot manipulation field in which an explicit task is performed and also applied to various robot applications.

### Description of Related Art

The existing robot system has been designed to perform only one task, but a recent learning-based robot system is developed to perform various tasks in a single model. This is an early stage of the development of a general-purpose robot. In particular, the possibility of the development is recently prominent in the execution of a language-guided robot task. In parallel, technology in which a task plan for a robot is made by using a natural language (NL) prompt and a large language model (LLM) is developed. U.S. Patent Application Publication No. US 2024-0253211 relates to technology in which a robot is controlled by using an LLM, and discloses contents in which robot control parameters and/or guides are specified in a natural language (NL) and may be connected to an LLM through an NL prompt or a query and an LLM module provides a task plan for a robot in the NL.

Furthermore, a monitoring technique for the task results of a robot is developed. Korean Patent Application Publication No. KR 2023-0000537 relates to a real-time process monitoring system using artificial intelligence (AI) and an assembly process monitoring technique using the real-time process monitoring system. The real-time process monitoring system includes an image acquisition unit that generates the image data of a set process environment and a process monitoring unit that monitors the suitability of a process based on the image data. Korean Patent Application Publication No. KR 2023-0000537 discloses contents in which the process monitoring unit generates a first area for a task object, a second area for a portion that is a task target within the task object, and a third area for a task subject that performs a task on the task target from image data that are input in time series, determines whether the task is performed for a preset time in the state in which the third area overlaps the second area, and determines the suitability of a process by comparing image data at a first time point right before the third area overlaps the second area and image data at a second time point, that is, a time point right after the third area overlaps the second area.

### SUMMARY OF THE INVENTION

An object of the present disclosure is to provide a method, control module, and robot system for detecting whether a robot has completed a task by considering context, which detect whether the execution of a given robot task has been successfully completed or has failed by considering context when the robot performs the task.

Another object of the present disclosure is to provide a method, control module, and robot system for detecting whether a robot has completed a task by considering context, which support that a robot performs a task more accurately and efficiently by comprehensively determining an environmental situation and a progress state of the task, by surpassing a simple determination of whether the task has been completed.

A further object of the present disclosure is to provide a method, control module, and robot system for detecting whether a robot has completed a task by considering context, which enable a robot to smoothly change into a next task when the robot succeeds in a task and can perform proper measures or a recovery procedure suitable for context when the robot fails in the task.

In order to accomplish the above objects, a method of detecting whether a robot has completed a task by considering context according to embodiments of the present disclosure may include receiving observation information related to the execution of a robot task, generating a prompt based on a goal related to the execution of the robot task and the received observation information, generating a task completion detection (TCD) function based on the generated prompt, and identifying whether the execution of the robot task is successful by using the generated TCD function.

The method of detecting whether a robot has completed a task by considering context may further include receiving the goal and observation information related to a robot and predicting a task to be performed by the robot based on the goal and the observation information related to the robot. The execution of the robot task may be the execution of the predicted task by the robot.

The observation information related to the execution of the robot task may include a sensor value detected by one or more sensors after the execution of the robot task.

The prompt may be instructions that are input to an interface of generative artificial intelligence (AI).

The prompt may include at least one of a system prompt including information related to a sensor and a user prompt including text generated based on the goal.

The information related to the sensor may include at least one of list information indicative of a list of sensors, sensor information indicative of characteristics of the sensors, mounting location information indicative of location at which the sensors are mounted, or a combination thereof.

The user prompt may further include information that defines an operating method of the TCD function and information that defines a function type of the TCD function.

The generating of the TCD function may include transmitting the prompt to a large language model (LLM) and receiving the TCD function from the LLM.

When the collected observation information includes an image, the TCD function may request a large multi-modal model (LMM) to identify whether the execution of the robot task is successful based on the image by invoking the LLM.

The TCD function may be generated once per goal and invoked whenever the execution of the robot task is repeated.

A control module for detecting whether a robot has completed a task by considering context according to embodiments of the present disclosure may include a storage configured to store a goal related to the execution of a robot task and a controller configured to receive observation information related to the execution of the robot task, generate a prompt based on the goal and the received observation information, generate a task completion detection (TCD) function based on the generated prompt, and identify whether the execution of the robot task is successful by using the generated TCD function.

The storage may further store observation information related to a robot. The controller may predict a task to be performed by the robot based on the goal and the observation information related to the robot. The execution of the robot task may be the execution of the predicted task by the robot.

The observation information related to the execution of the robot task may include a sensor value detected by one or more sensors after the execution of the robot task.

The prompt may be instructions that are input to an interface of generative artificial intelligence (AI).

The prompt may include at least one of a system prompt including information related to a sensor and a user prompt including text generated based on the goal.

The information related to the sensor may include at least one of list information indicative of a list of sensors, sensor information indicative of characteristics of the sensors, mounting location information indicative of location at which the sensors are mounted, or a combination thereof.

The user prompt may further include information that defines an operating method of the TCD function and information that defines a function type of the TCD function.

The TCD function may be generated once per goal and invoked whenever the execution of the robot task is repeated.

A robot system for detecting whether a robot has completed a task by considering context according to embodiments of the present disclosure may include a robot main body, a sensor unit configured to generate observation information related to the execution of a robot task by the robot main body, a storage configured to store a goal related to the execution of the robot task, and a controller configured to generate a prompt based on the goal and the generated observation information, generate a task completion detection (TCD) function based on the generated prompt, and identify whether the execution of the robot task is successful by using the generated TCD function.

The storage may further store observation information related to the robot main body. The controller may predict a task to be performed by the robot main body based on the goal and the observation information related to the robot main body. The execution of the robot task may be the execution of the predicted task by the robot main body.

According to the method, control module, and robot system for detecting whether a robot has completed a task by considering context according to embodiments of the present disclosure, whether the execution of a robot task is successful is determined by comprehensively considering an environmental factor and a task progress situation when the robot performs the task in addition to whether the robot has completed the task. Accordingly, the completion of the execution of the robot task can be recognized more precisely.

The LMM determines whether the execution of a robot task is successful by automatically analyzing various sensors mounted on the robot according to the task in addition to visual information. Accordingly, it is possible to increase the accuracy of determining the completion of the execution of a robot task through a combination of sensors suitable for the task.

It is possible to greatly improve efficiency of the execution of a continuous task by providing a function for identifying whether the execution of a robot task has been completed and then enabling the robot to automatically smoothly change into a next task or autonomously perform a recovery procedure when the robot fails in the task.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a flowchart illustrating an execution process of an operating method of a task completion detector according to an embodiment of the present disclosure.

FIG. 2 is a flowchart illustrating some of an execution process of an operating method of the task completion detector according to an embodiment of the present disclosure.

FIG. 3 is a diagram illustrating an example of a prompt generated by the task completion detector according to embodiments of the present disclosure.

FIG. 4 is a flowchart illustrating other some of an execution process of an operating method of the task completion detector according to an embodiment of the present disclosure.

FIG. 5 is a diagram illustrating an example of a task completion detection (TCD) function that is output by a large multi-modal model (LMM) according to embodiments of the present disclosure.

FIG. 6 is a flowchart illustrating some of an execution process of an operating method of the task completion detector according to another embodiment of the present disclosure.

FIG. 7 is a flowchart illustrating other some of an execution process of an operating method of the task completion detector according to another embodiment of the present disclosure.

FIG. 8 is a configuration diagram illustrating a configuration of a robot system according to an embodiment of the present disclosure.

FIG. 9 is a flowchart illustrating an execution process of a method of detecting whether a robot has completed a task by considering context according to an embodiment of the present disclosure.

### DESCRIPTION OF THE PREFERRED EMBODIMENTS

The present disclosure may be modified in various ways and may have various embodiments. Specific embodiments are to be illustrated in the drawings and to be described in the detailed description. It is however to be understood that the present disclosure is not intended to be limited to the specific embodiments, but that the specific embodiments include all of modifications, equivalents and/or substitutions included in the spirit and technical scope of the present disclosure.

For the following detailed description of the present disclosure, reference is made to the accompanying drawings as examples of specific embodiments. The embodiments are described in detail in order for those skilled in the art to readily implement the embodiments. It is to be understood that various embodiments are different from each other, but do not need to be exclusive. For example, a specific shape, structure, and characteristic described in this specification may be implemented as another embodiment without departing from the spirit and scope of the present disclosure in relation to an embodiment. It is also to be understood that the position or arrangement of each component within each disclosed embodiment may be changed without departing from the spirit and scope of the present disclosure. Accordingly, the following detailed description is not intended to have a limited meaning. The range of the embodiment is restricted by only the claims along with all ranges equivalent to that written in the claims if it is appropriately described.

In the drawings, similar reference numerals denote the same or similar functions in several aspects. The shapes, sizes, etc. of components in the drawings may be exaggerated for a clearer description. Furthermore, the term “and/or” may include a combination of a plurality of related and described items or any one of a plurality of related and described items. In embodiments of the present disclosure, the terms “part”. “unit”, and “module” used may include one or more components, and may include a software component and/or a hardware component.

In embodiments of the present disclosure, terms, such as a first and a second, may be used to describe various components, but the components should not be restricted by the terms. The terms are used to only distinguish one component from the other components. For example, a first component may be named a second component without departing from the scope of rights of the present disclosure. Likewise, a second component may be named as a first component.

When it is described that one component is “connected” or “coupled” to the other component, it should be understood that the two components may be directly connected or coupled, but another component may be present between the two components. In contrast, when it is described that one component is “directly connected” or “directly coupled” to the other component, it should be understood that another component is not present between the two components.

Components described in the embodiments are independently illustrated in order to indicate different and characteristic functions. It does not mean that each of the components is formed of separate hardware or a piece of a software unit. That is, the components are arranged and included, for convenience of a description, and at least two of the components may be combined to form one component or one component may be divided into a plurality of components that perform functions. An embodiment in which some components are integrated or embodiments in which some components are separated are also included in the scope of rights of the present disclosure unless they depart from the essence of the present disclosure.

The terms used in the embodiments are used to only describe specific embodiments and are not intended to restrict the present disclosure. An expression of the singular number should be construed as including an expression of the plural number unless clearly defined otherwise in the context. It is to be understood that in the embodiments, a term, such as “include (or comprise)” or “have”, is intended to designate the presence of a characteristic, a number, a step, an operation, a component, a part or a combination of them described in the specification and does not exclude the possible existence or addition of one or more other characteristics, numbers, steps, operations, components, parts or combinations of them in advance. That is, in the embodiments, contents describing that a specific component is “included” do not exclude a component other than a corresponding component, and mean that an additional component may also be included in an implementation of the present disclosure or the scope of the technical spirit of the present disclosure.

In the embodiments, the term “at least one” may mean one of one or more numbers, such as 1, 2, 3, and 4. In the embodiments, “a plurality of” may mean one of two or more numbers, such as 2, 3, and 4.

At least some of parts, units, and modules described in the embodiments may be program modules, and may communicate with an external device or system.

The program modules may perform a function or operation according to an embodiment or may embrace a routine, a subroutine, a program, an object, a program component, and a data structure that implement an abstract data type according to an embodiment, but is not limited thereto.

Some components disclosed in the present disclosure may not be essential components that perform essential functions, but may be optional components for improving only performance. The embodiments may be implemented with only components essential to implement the essence of the present disclosure other than components used to improve only performance, and a structure including only essential components other than optional components used to improve only performance is also included in the scope of rights of the present disclosure.

Hereinafter, embodiments are described in detail with reference to the accompanying drawings in order for a person having ordinary knowledge in the art to easily implement the embodiments. In describing the embodiments, a detailed description of a related known component or function will be omitted if it is deemed to make the subject matter of the present disclosure vague. Furthermore, in the drawings, the same reference numeral is used in the same component, and a redundant description of the same component is omitted.

In embodiments of the present disclosure, the execution of a robot task may be applied to various tasks of a robot. In some embodiments, the execution of a robot task is a robot manipulation task using a robot arm. In some embodiments, the execution of a robot task is a task in which a robot and human interacts with each other. A robot system according to embodiments of the present disclosure may be used in various robot tasks.

Embodiments of the present disclosure propose technology in which whether a robot has completed the execution of a task by considering context is recognized in order for the robot to automatically perform various tasks. The technology may be the most important precondition for enabling a robot to automatically perform various tasks. To determine whether a robot has succeeded in the execution of a task by comprehensively determining an environmental factor and a task progress situation, in addition to whether the robot has simply completed the task, is essentially required in order for the robot to successfully perform various tasks. That is, the robot can clearly identify whether the task is successful and can smoothly change into a next task. Furthermore, when the robot fails in the task, the robot may autonomously re-attempt the task through proper measures or a recovery process suitable for context or may find another solution.

In particular, to determine whether a robot has succeeded in a task by considering context, which is proposed in embodiments of the present disclosure, is important in that 1) environmental context needs to be considered in order to determine whether to continuously perform or to stop a task, 2) there is difficulty in performing a continuous long-horizon task if the change of a task is not smooth when the execution of the task is successful, 3) a task success ratio can be increased through measures and a recovery process into which environmental context has been incorporated when a task fails, and 4) it is easy to determine a simple task, such as pick and place or open/close, but to determine whether a task is successful by considering context is essential in a complex environment.

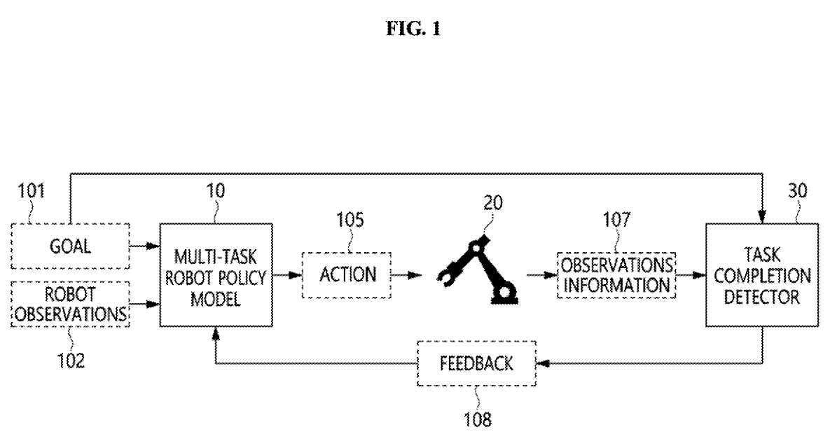

FIG. 1 is a flowchart illustrating an execution process of an operating method of a task completion detector according to an embodiment of the present disclosure.

Referring to FIG. 1, a robot system 1 according to embodiments of the present disclosure may include a multi-task robot policy model 10, a robot 20, and a task completion detector 30. The multi-task robot policy model 10 and the task completion detector 30 may each be implemented as a program module or a hardware component.

The multi-task robot policy model 10 may receive a goal 101, robot observations 102. In this case, the goal 101 may include language instruction. For example, the goal 101 may be set by a user. The multi-task robot policy model 10 may receive the goal 101 from a user.

The robot observations 102 may include visual information and state information of the robot 20 and an environment to which the robot 20 belongs. The visual information may include observation information from a camera. The visual information may be an image or a moving image. The camera may be attached to the robot 20 and may be installed in the environment to which the robot 20 belongs.

The state information is information indicative of the state of the robot 20 and may include information sensed by a sensor attached to the robot 20 or a sensor for the robot 20 in addition to the camera. In this case, the sensor attached to the robot 20 or the sensor for the robot 20 may include force, tactile, torque, weight, thermal imaging, temperature, and vibration sensors in addition to a microphone. The robot observations 102 may be freely configured by a user. The user may attach a sensor that is determined by the user to the robot 20 and may install a sensor in an environment to which the robot 20 belongs.

The multi-task robot policy model 10 may predict an action 105 to be currently performed by the robot 20 and transmit the action to the robot 20. The multi-task robot policy model 10 may predict the action 105 to be performed by the robot 20 based on at least one of the goals 101 and the robot observations 102. Hereinafter, the execution of a robot task means that the robot 20 performs a task predicted by the multi-task robot policy model 10.

The robot 20 may transmit observation information 107 for the task completion detector 30 to the task completion detector 30. The observation information 107 may include sensor information for a sensor attached to the robot 20 or the robot 20. In this case, the sensor may include force, tactile, torque, weight, thermal imaging, temperature, and vibration sensors in addition to a camera and a microphone. The sensor information may indicate information that is photographed or sensed by a corresponding sensor. A user may configure a sensor attached to the robot 20 and a sensor for the robot 20 and may configure information sensed by a corresponding sensor.

The task completion detector 30 may determine the success or failure of the execution of a robot task based on the goal 101 and the observation information 107 for task completion detection (TCD), and may transmit a determination result 108 (i.e., feedback) to the multi-task robot policy model 10.

The multi-task robot policy model 10 may be aware of whether to change into a next task or continuously perform a current task based on whether a task is successful or fails. The multi-task robot policy model 10 may determine whether to change a task based on information regarding the success or failure of the task and may infer a robot action for a determined task.

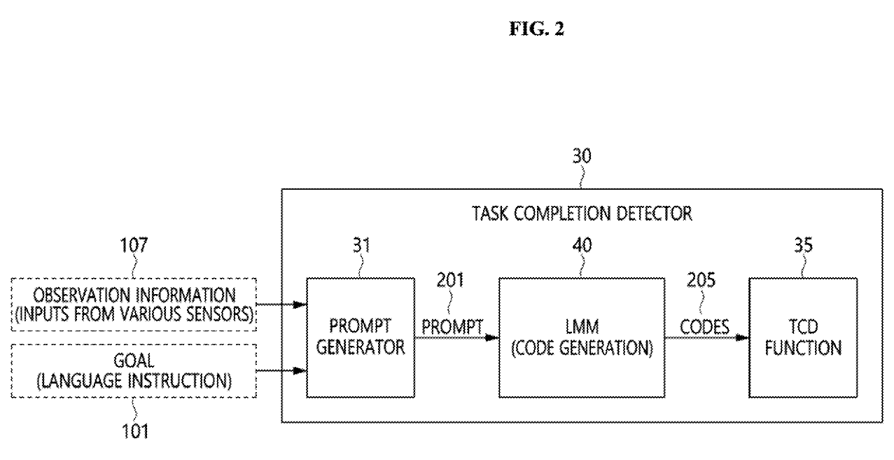

FIG. 2 is a flowchart illustrating some of an execution process of an operating method of the task completion detector according to an embodiment of the present disclosure. FIG. 2 illustrates a flowchart when the task completion detector generates TCD codes.

Referring to FIG. 2, when the observation information 107 and the goal 101 to be performed are given, the task completion detector 30 may generate a prompt based on the observation information 107 and the goal 101 and may generate TCD codes by using the generated prompt. The task completion detector 30 may include a prompt generator 31 and a large multi-modal model (LMM) 40.

When the observation information 107 and the goal 101 to be performed are given, the prompt generator 31 may generate a prompt to be transmitted to the LMM 40, based on the observation information 107 and the goal 101. In this case, the prompt is an instruction that is input to an interface of generative artificial intelligence (AI), and may mean an input sentence that enables the generative AI to generate an output. In embodiments of the present disclosure, an instruction that is input to the LMM 40 by the prompt may refer to an input sentence that enables the LMM 40 to generate the TCD codes.

The prompt may consist of a system prompt and a user prompt. The system prompt may include information related to a sensor. The information related to the sensor may include list information indicative of a list of sensors, sensor information indicative of the characteristics of a sensor, and mounting location information indicative of a location at which a sensor is mounted. The user prompt may include text generated based on the goal, information that defines an operating method of a TCD function to be generated, and information that defines a function type of the TCD function.

The LMM 40 is a model capable of integrally interpreting various types of information (including image information), such as text, an image, and video, including a large language model (LLM), like a vision language model (VLM). For example, the LMM 40 may be generative AI, and may be GPT4v or CLOVA X, for example.

The prompt generator 31 may have information on the type of robot sensor currently attached to a robot and a sensor value. For example, when a robot performs a water pouring task, the prompt generator 31 may have a normal sensor value for a weight change. When a robot performs a screw tightening task, the prompt generator 31 may have normal sensor values of a force sensor, a tactile sensor, and a torque sensor. When a robot performs a safe monitoring task, the prompt generator 31 may have normal sensor values of a thermal imaging sensor and a temperature sensor.

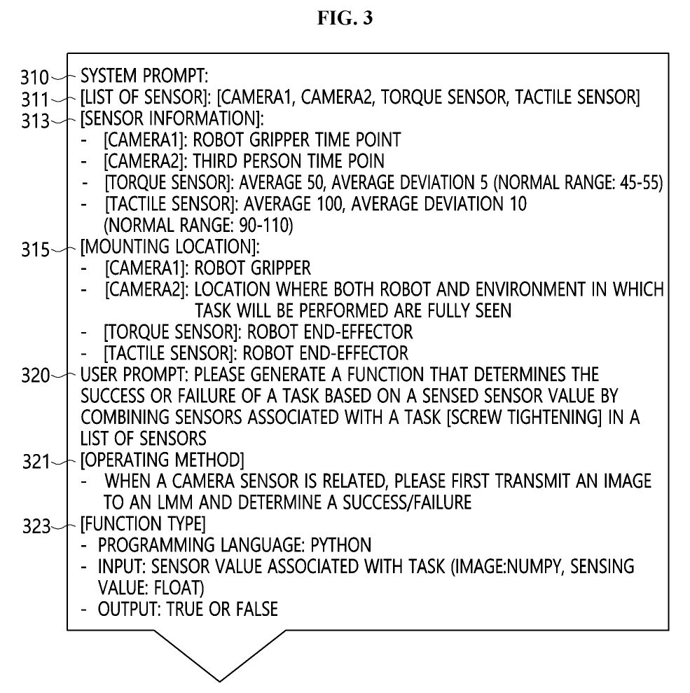

FIG. 3 is a diagram illustrating an example of a prompt that is generated by the task completion detector according to embodiments of the present disclosure.

Referring to FIG. 3, the prompt generator 31 may input all pieces of information not the existing IF-ELSE-based structure to a prompt 201 and may properly generate the prompt 201 so that the LMM 40 may determine and generate the TCD codes 205. The prompt 201 includes text reading that context for an environment needs to be considered.

FIG. 3 is an example of a prompt that is output by the prompt generator 31 for a screw tightening task. A form of the prompt output by the prompt generator 31 is illustrated in FIG. 3. Information included in a system prompt 310 may be owned by the prompt generator 31. Furthermore, the information included in the system prompt 310 may include list information 311 indicative of a list of sensors owned by the prompt generator 31, sensor information 313, and mounting location information 315 indicative of the locations at which the sensors are mounted. The list of sensors owned by the prompt generator 31 may be a list of all of sensors that are necessary to determine a task success/failure. The sensor information 313 may include information on the types, characteristics, and ranges of the sensors included in the list of sensors. The mounting location information 315 may include information indicative of the locations at which the sensors included in the list of sensors are mounted.

In a user prompt 320, a task name such as [screw tightening] may be received from the goal 101, that is, an input to the prompt generator 31. The user prompt 320 associates the input goal 101 with text by mapping the input goal 101 to the text and may include the type of generation function [function type] 323 to be written and an operating method [operating method] 321 of the generation function to be written. The operating method [operating method] 321 may generate a function as a user wants, as in the user prompt 320 of FIG. 3, an image may be transmitted to the LMM, and a user may use a technique that is directly developed by the user.

The LMM 40 may generate the TCD codes 205 based on the prompt 21. The LMM 40 may generate the TCD codes by considering general context information based on a task, an environment, and the state of the robot 20, based on the sensors of the robot 20 and the values of the sensors. The output codes 205 may have a form of a function and may be a TCD function 35 that receives several pairs (i.e., a sensor type and a sensor value). The TCD function 35 may have a form in which the TCD function returns a success or a failure based on several pairs of inputs each consisting of a sensor type and a sensor value.

In some embodiments, time points at which the generation of the prompt 201 and the generation of the TCD codes 205 are implemented may each be only once when a new task is updated. The LMM 40 may be performed only once at an early stage per task because a long inference time is taken due to a great computational load, and may then continue to detect whether a task is completed based on generated. However, if a complex sensor value (e.g., an image) needs to be analyzed, a function may invoke the LMM. In another embodiment, when an environment is fully updated, the implementations of the generation of the prompt 201 and the generation of the TCD codes 205 may be performed.

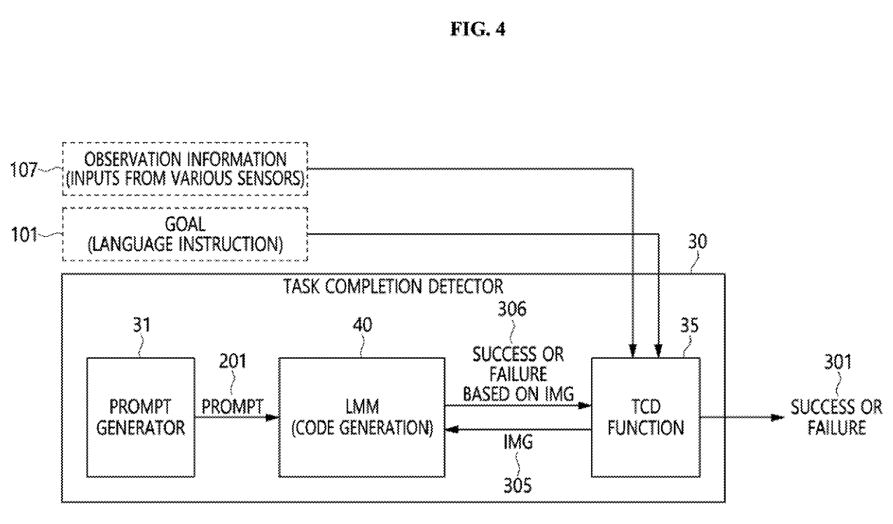

FIG. 4 is a flowchart illustrating other some of an execution process of an operating method of the task completion detector according to an embodiment of the present disclosure.

Referring to FIG. 4, the task completion detector 30 may determine whether the execution of a robot task is successful by executing the TCD function 35, and may transmit the result 301 of whether the execution of the robot task is successful to the multi-task robot policy model 10. When the TCD codes 205 are generated, the task completion detector 30 may invoke the TCD function 35 whenever the robot 20 takes an action. That is, the task completion detector 30 determines whether the execution of the robot task is successful based on the generated TCD codes 205 and may be continuously invoked when the robot 20 performs a task. In this case, when a complex sensor value, such as an image (IMG) 305, is input, the TCD function 35 may first determine whether the execution of a robot task for the image 305 is successful by invoking the LMM 40 and may then determine a result based on another sensor value. When the image 305 is input from the TCD function 35, the LMM 40 may determine whether the execution of a robot task for the image 305 is successful (306) and may transmit a determination result 306 to the TCD function 35. The TCD function 35 may determine whether the execution of the robot task is successful based on the determination result 306, the observation information 107, and the goal 101, and may transmit the result 301 of whether the execution of the robot task is successful to the multi-task robot policy model 10.

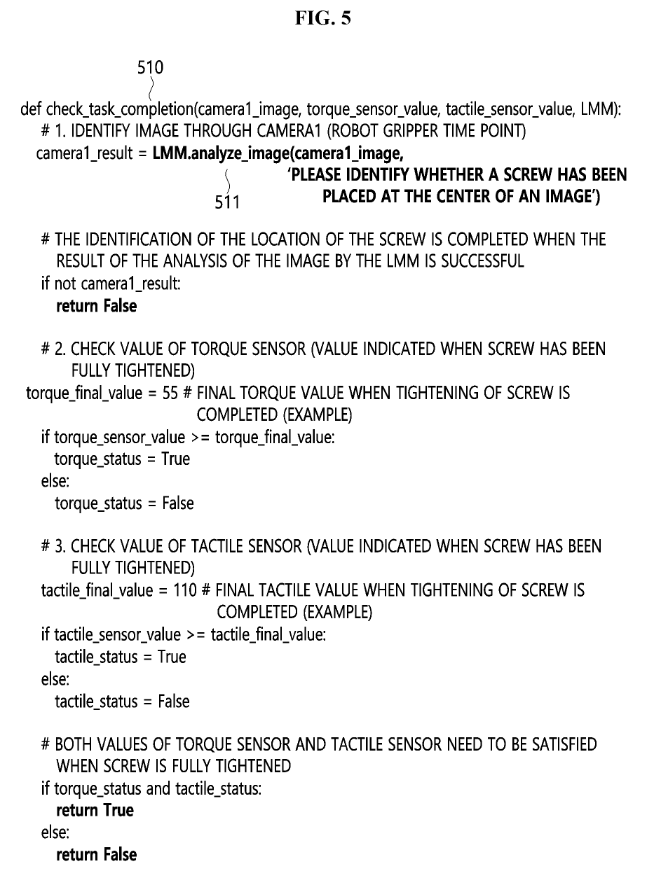

FIG. 5 is a diagram illustrating an example of the TCD function that is output by the LMM according to embodiments of the present disclosure.

Referring to FIG. 5, a check_task_completion function 510 is an example of the TCD function. An LMM.analyze_image function 511 included in the check_task_completion function 510 is a function that identifies whether a screw has been properly arranged and that returns “true” or “false” based on each sensing value.

The check_task_completion function 510 enables the LMM 40 to first determine whether the execution of a robot task is successful based on the image by invoking the LMM.analyze_image function 511 and may receive the determination result 306 from the LMM 40. The check_task_completion function 510 may determine whether the execution of the robot task is successful based on the determination result 306 and may transmit the result 301 of whether the execution of the robot task is successful to the multi-task robot policy model 10. When the LMM 40 determines that the execution of the robot task fails based on the image 305, the check_task_completion function 510 may transmit the failure 301 of the execution of the robot task to the multi-task robot policy model 10.

When the LMM 40 determines that the execution of the robot task is successful based on the image 305, the check_task_completion function 510 may identify whether the screw has been fully tightened based on a torque sensor value and identify whether the screw has been fully tightened based on a tactile sensor value. The check_task_completion function 510 may determine whether the execution of the robot task is successful based on the result of the identification and transmit the result 301 of whether the execution of the robot task is successful to the multi-task robot policy model 10. In this case, when the screw is fully tightened based on both the torque sensor value and the tactile sensor value as the result of the identification, the check_task_completion function 510 may transmit the success 301 of the execution of the robot task to the robot policy model 10. If not, the check_task_completion function 510 may transmit the failure 301 of the execution of the robot task to the multi-task robot policy model 10.

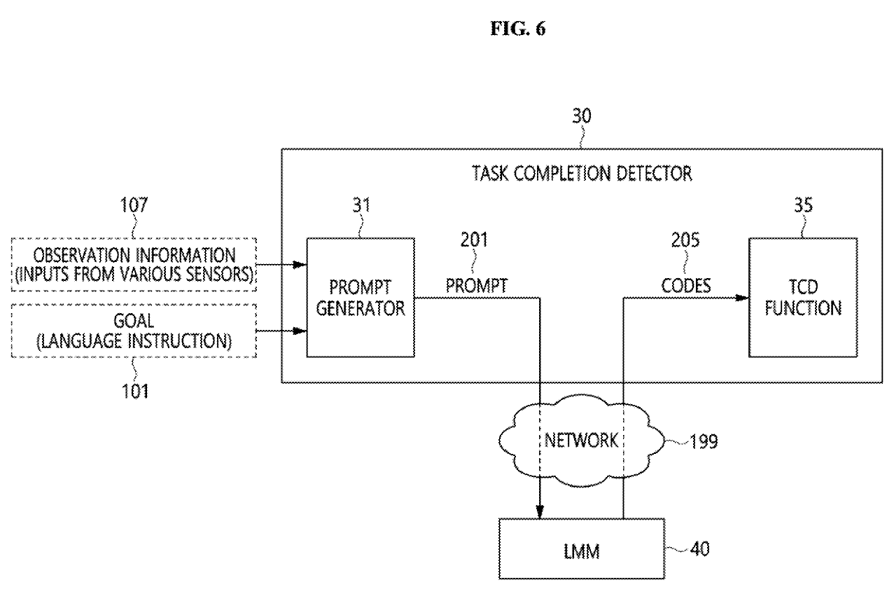

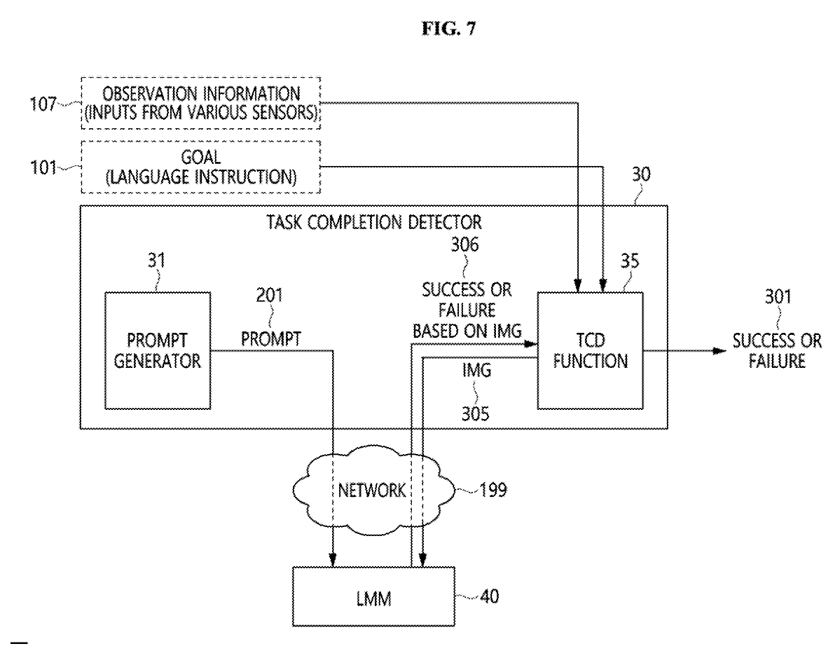

FIG. 6 is a flowchart illustrating some of an execution process of an operating method of the task completion detector according to another embodiment of the present disclosure. FIG. 7 is a flowchart illustrating other some of an execution process of an operating method of the task completion detector according to another embodiment of the present disclosure.

Referring to FIGS. 6 and 7, unlike in the embodiments described with reference to FIGS. 2 and 4, the LMM 40 is not included within the task completion detector 30 and may be disposed outside the task completion detector 30. The task completion detector 30 and the LMM 40 may be connected over a network 199. The task completion detector 30 may remotely invoke the LMM 40. The task completion detector 30 and the LMM 40 may transmit and receive data over the network 199. That is, the prompt 201 may be transmitted from the task completion detector 30 to the LMM 40 over the network 199. The TCD codes 205 may be transmitted from the LLM 40 to the task completion detector 30 over the network 199. In this case, the network 199 may be a private network or an Internet network and may include a wired network or a wireless network. The network 199 may denote an ad hoc network, Intranet, Extranet, Bluetooth, ZigBee, a virtual private network (VPN), a local area network (LAN), a wireless LAN (e.g., IEEE 802.11b, IEEE 802.11a, IEEE802.11g, or IEEE802.11n), wireless broadband (WIBro), a wide area network (WAN), a wireless WAN (WWAN), a metropolitan area network (MAN), Internet, a part of the Internet, a part of a public switched telephone network (PSTN), a plain old telephone service (POTS) network, a cellular phone network, a wireless network, a Wi-Fi® network, other types of networks, or one or more portions of a network which may be a combination of two or more of such networks, and may denote one or more portions of a network to which other types of networks are connected. For example, the network or a part of the network may include a wireless or cellular network. The connection may be a code division multiple access (CDMA) connection, a global system for mobile communications (GSM) connection, or other types of cellular or wireless connections. In such an example, the connection may be implemented with an arbitrary connection, among single carrier radio transmission technology (1xRTT), evolution-data optimized (EVDO) technology, general packet radio service (GPRS) technology, enhanced data rates for GSM evolution (EDGE) technology, third generation partnership project (3GPP) including 3G, fourth generation (4G) wireless) networks, the universal mobile telecommunications system (UMTS), high speed packet access (HSPA), worldwide interoperability for microwave access (WiMAX), the long term evolution (LTE) standard, other things defined by various standard-configuration organizations, other long-distance protocols, or various types of data transmission technologies such as another data transmission technology.

Furthermore, the task completion detector 30 may request the LMM 40 to determine whether the execution of the robot task is successful based on the image 305 by transmitting the image 305 to the LMM 40 over the network 199. The LMM 40 may determine whether the execution of the robot task for the image 305 is successful (306) and transmit the determination result 306 to the TCD function 35 over the network 199.

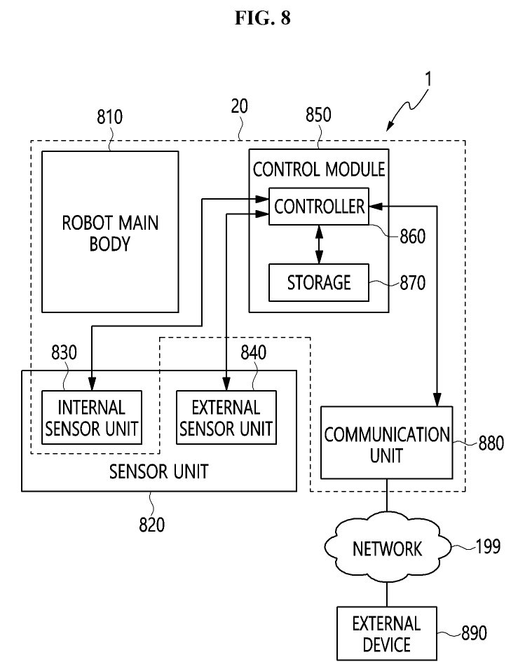

FIG. 8 is a configuration diagram illustrating a configuration of a robot system according to an embodiment of the present disclosure.

Referring to FIG. 8, the robot system 1 according to embodiments of the present disclosure may include a robot main body 810, a sensor unit 820, a control module 850, a communication unit 880, and an external device 890.

The robot main body 810 includes hardware components of the robot 20, and may include joint devices that move a robot arm, a robot leg, a robot body, and the robot head and each portion.

The sensor unit 820 may include force, tactile, torque, weight, thermal imaging, temperature, and vibration sensors in addition to a camera and a microphone. A list of sensors is not limited to such sensors, and a user may variously configure sensors if necessary. The sensor unit 820 may include an internal sensor unit 830 and an external sensor unit 840. The internal sensor unit 830 may refer to a sensor attached to the robot main body 810. The external sensor unit 840 is a sensor that is physically separated from the robot main body 810 and may be installed in an environment around the robot main body 810. For example, when the camera is attached to the robot main body 810, the camera may be included in the internal sensor unit 830. When the camera is physically separated from the robot main body 810, the camera may be included in the external sensor unit 840.

The sensor unit 820 may detect a surrounding environment of the robot main body 810 and the robot 810 and output a detected sensor value to the control module 850.

The control module 850 may include a controller 860, a storage 870, and the communication unit 880. The control module 850 may be attached to the robot main body 810 and may be physically separated from the robot main body 810. The program modules may be included in the control module 860 in the form of an operating system, an application program module, and other program modules.

The program modules may be stored in physically various known storage devices. Furthermore, at least some of such program module may be stored in a remote storage device capable of communicating with the communication unit 880.

The controller 860 may control an operation of the robot 20, may control the sensor unit 820, and may receive a sensor value from the sensor unit 820. The controller 850 may execute the multi-task robot policy model 10 and the task completion detector 30.

The controller 860 may be a semiconductor device that executes processing instructions stored in the storage 870. The controller 860 may be at least one hardware processor. The controller 860 may include one or more cores and may include a processor for data analysis and deep learning, such as a central processing unit (CPU), graphics processing unit (GPU), digital signal processor (DSP), application specific integrated circuit (ASIC), general purpose graphics processing unit (GPGPU), and tensor processing unit (TPU) of the control module 850. The controller 860 may perform data processing for the training of a deep learning network according to an embodiment of the present disclosure by reading a computer program stored in the storage 870.

The program modules may consist of instructions or codes that are performed by at least one processor of the controller 860.

The controller 860 executes a command, and may perform an operation associated with the robot 20. For example, the controller 860 may control a hardware component of the robot main body 810 based on an instruction that is retrieved from the storage 870.

The controller 860 may execute instructions or codes of the part, unit, and module described in the embodiments.

The storage 870 may store the information included in the system prompt 310 and the information included in the user prompt 320. The storage 870 may denote memory and/or storage. The storage 870 may include various types of volatile or nonvolatile storage media. For example, the memory may include at least one of ROM and RAM.

The storage 870 may store information on the type of a robot sensor that is currently attached to the robot and sensor values. For example, the storage 870 may store a normal sensor value for a weight change when a water pouring task is performed, may store normal sensor values of force sensor, tactile sensor, and torque sensor values when a screw tightening task is performed, and may store normal sensor values of a thermal imaging sensor and a temperature sensor when a safe monitoring task is performed.

The communication unit 880 may transmit and receive signals or data to and from the external device 890, another server, and another terminal over the network 199. The communication unit 880 may transmit the prompt 201 and the image 305 to the LMM 40 of the external device 890 over the network 199. The controller 860 may request the LMM 40 of the external device 890 to determine whether the execution of a robot task is successful based on the image 305, by controlling the communication unit 880 to transmit the image 305 to the LMM 40 of the external device 890.

The communication unit 880 may be attached to the robot main body 810 and may be physically separated from the robot main body 810.

The communication unit 880 may transmit and receive signals or data to and from the external device 890 or another terminal by using a LAN, a wireless LAN (e.g., IEEE 802.11b, IEEE 802.11a, IEEE802.11g, or IEEE802.11n), wireless broadband (WIBro), Bluetooth, or ZigBee.

The external device 890 may be a server that provides a generative AI service. The external device 890 may include the LLM 40. The LLM 40 may be executed on the external device 890 and may be remotely invoked through the control module 850. The external device 890 may generate the TCD function 35 and transmit the generated TCD function 35 to the communication unit 880. The LMM 40 of the external device 890 may determine whether the execution of a robot task for the image 305 is successful (306), which has been requested by the controller 860, and may transmit the determination result 306 to the communication unit 880 over the network 199.

In some embodiments, the robot 20 according to embodiments of the present disclosure may include the robot main body 810, the internal sensor unit 830, the control module 850, and the communication unit 880. The internal sensor unit 830, the control module 850, and the communication unit 880 may be attached inside or outside the robot main body 810 and may form the robot 20 according to embodiments of the present disclosure.

In some embodiments, the robot 20 according to embodiments of the present disclosure may include the robot main body 810 and the internal sensor unit 830. The internal sensor unit 830 may be attached inside or outside the robot main body 810 and may form the robot 20 according to embodiments of the present disclosure. The control module 850 and the communication unit 880 may be physically separated from the robot main body 810.

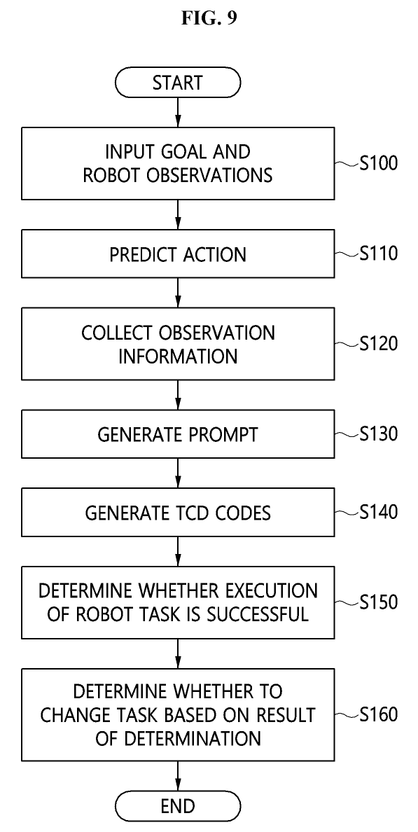

FIG. 9 is a flowchart illustrating an execution process of a method of detecting whether a robot has completed a task by considering context according to an embodiment of the present disclosure.

Referring to FIG. 9, the controller 860 receives the goal 101 and the robot observations 102 (S100). In this case, the goal 101 may include language instruction. For example, the goal 101 may be set by a user. The multi-task robot policy model 10 may receive the goal 101 from a user.

The robot observations 102 may be observation information related to the robot 20. The observation information related to the robot 20 may include visual information and state information of the robot 20 and an environment to which the robot 20 belongs. The visual information may include the observation information from the camera. The visual information may be an image or a moving image. The camera may be attached to the robot 20, and may be installed in an environment to which the robot 20 belongs.

The state information is information indicative of the state of the robot 20 and may include information sensed by a sensor attached to the robot 20 or a sensor for the robot 20 in addition to the camera. In this case, the sensor attached to the robot 20 or the sensor for the robot 20 may include force, tactile, torque, weight, thermal imaging, temperature, and vibration sensors in addition to a microphone. The robot observations 102 may be freely configured by a user. A user may attach a sensor determined to be required by the user to the robot 20 and may install a sensor in an environment to which the robot 20 belongs.

The controller 860 predicts the action 105 to be currently performed by the robot 20 (S110). In step S110, the controller 860 may control the robot main body 810 to perform the predicted action. The controller 860 may predict the action 105 to be performed by the robot 20 based on at least one of the goals 101 and the robot observations 102. Hereinafter, the execution of a robot task means that the robot 20 performs the action predicted in step S110.

The controller 860 collects observation information 107 for detecting whether the execution of the robot task has been completed (S120). The observation information 107 may be observation information related to the execution of the robot task. The observation information related to the execution of the robot task may include sensor information related to a sensor included in the sensor unit 820. In this case, the sensor information may indicate information photographed or sensed by the corresponding sensor. In step S120, the controller 860 may receive a sensor value from the sensor unit 820.

The controller 860 generates a prompt based on the observation information 107 and the goal 101 collected in step S120 (S130). The controller 860 may generate the prompt to be transmitted to the LMM 40, based on the observation information 107 and the goal 101. In this case, the prompt is instructions that are input to the interface of generative AI and may refer to an input sentence that enables the generative AI to generate an output. In embodiments of the present disclosure, the prompt is instructions that are input to the LMM 40 and may refer to an input sentence that enables the LMM 40 to generate the TCD codes. In this case, the LMM 40 may be stored by the storage 870 and executed by the controller 860, in the form corresponding to the embodiments described with reference to FIGS. 2 and 4. The LMM 40 may be executed by the external device 890 in the form corresponding to the embodiments described with reference to FIGS. 6 and 7.

The controller 860 may input all pieces of information, not the existing IF-ELSE-based structure, to the prompt 201, and properly generate the prompt 201 so that the LMM 40 can determine and generate the TCD codes 205. The prompt 201 includes text reading that context for an environment needs to be considered. For example, in step S130, the controller 860 may generate the prompt illustrated in FIG. 3.

The controller 860 generates the TCD codes 205 based on the prompt 21 by using the LMM 40 (S140). The LMM 40 may generate the TCD codes 205 by considering general context information based on a task, an environment, and the state of the robot 20, based on the sensors of the robot 20 and the values of the sensors. The output codes 205 may have a form of a function and may be the TCD function 35 that receives several pairs (i.e., a sensor type and a sensor value). The TCD function 35 may have a form in which the TCD function returns a success or a failure based on several pairs of inputs each consisting of a sensor type and a sensor value.

In some embodiments, time points at which the generation of the prompt 201 and the generation of the TCD codes 205 are implemented may each be only once when a new task is updated. The LMM 40 may be performed only once at an early stage per task because a long inference time is taken due to a great computational load, and may then continue to detect whether a task is completed based on generated. However, if a complex sensor value (e.g., an image) needs to be analyzed, a function may invoke the LMM. In another embodiment, when an environment is fully updated, the implementations of the generation of the prompt 201 and the generation of the TCD codes 205 may be performed.

The controller 860 determines whether the execution of the robot task is successful by executing the TCD function (S150). When the TCD codes 205 are generated, the controller 860 may invoke the TCD function 35 whenever the robot 20 takes an action. That is, the TCD function may determine whether the task is successful based on the generated TCD codes 205 and may be continuously invoked when the robot 20 performs a task. In this case, when a complex sensor value, such as the image 305, is input, the TCD function 35 may first determine whether a task for the image 305 is successful by invoking the LMM 40 and may then determine a result based on another sensor value. When the image 305 is input from the TCD function 35, the LMM 40 may determine whether the execution of a robot task for the image 305 is successful (306). The TCD function 35 may determine whether the execution of the robot task is successful based on the determination result 306, the observation information 107, and the goal 101, and may transmit the result 301 of whether the execution of the robot task is successful to the multi-task robot policy model 10. In some embodiments, in step S150, the controller 860 may determine whether the execution of the robot task is successful by executing the check_task_completion function 510 illustrated in FIG. 5.

The controller 860 may determine whether to change into a next task or continue to perform a current task based on the determination result in step S150 (S160). In step S160, the controller 860 may determine to change a task based on the determination result in step S150, and may infer a robot action for the determined task. In step S160, when the task of the robot 20 is successful, the controller 860 may control the robot to change into a next task smoothly. When the task of the robot fails, the controller 860 may control the robot to perform proper measures or a recovery procedure suitable for context.

In the aforementioned embodiments, in applying specified processing to a specified target, a specified condition may be required. If it has been described that specified processing is performed under a specified determination, when it is described that whether the specified condition is satisfied is determined based on a specified coding parameter or that a specified determination is made based on a specified coding parameter, it may be interpreted that the specified coding parameter may be substituted with another coding parameter. In other words, the coding parameter that affects the specified condition or the specified determination may be considered as being merely exemplary. It may be understood that a combination of one or more other coding parameters in addition to the specified coding parameter may perform a role as the specified coding parameter.

In the aforementioned embodiments, although the methods have been described based on the flowcharts in the form of a series of steps or blocks, the present disclosure is not limited to the sequence of the steps, and some of the steps may be performed in the sequence different from that of other steps or may be performed simultaneously with other steps. Furthermore, those skilled in the art will understand that the steps shown in the flowchart are not exclusive and the steps may include additional steps or that one or more steps in the flowchart may be deleted without affecting the scope of rights of the present disclosure.

The aforementioned embodiments include various aspects of examples. Although all kinds of possible combinations for representing the various aspects may not be described, those skilled in the art will understand that other possible combinations are possible in addition to an explicitly described combination. Accordingly, the present disclosure should be construed as including all other replacements, modifications, and changes which fall within the scope of the claims.

The aforementioned embodiments according to the present disclosure may be implemented in the form of a program readable through various computer means, and may be written in a computer-readable recording medium. In this case, the computer-readable recording medium may include program instructions, a data file, and a data structure alone or in combination. The program instructions written in the computer-readable recording medium may be specially designed and constructed for the present disclosure, or may be known and available to those skilled in computer software.

The computer-readable recording medium may include information that is used in embodiments of the present disclosure. For example, the computer-readable recording medium may include a bit stream. The bit stream may include the information described in the embodiments of the present disclosure.

The bit stream may include a computer-executable code and/or program. The computer-executable code and/or program may include the pieces of information described in the embodiments, and may include the syntax elements described in the embodiments. In other words, the pieces of information and the syntax elements described in the embodiments may be considered as computer-executable codes within a bit stream, and may be considered as at least a part of a computer-executable code and/or program that is expressed as a bit stream.

The computer-readable recording medium may include a non-transitory computer-readable medium.

Examples of the computer-readable recording medium may include a hardware device specially configured to store and execute a program instruction, such as magnetic media such as a hard disk, a floppy disk, and a magnetic tape, optical media such as CD-ROM and a DVD, magneto-optical media such as a floptical disk, ROM, RAM, and flash memory. Examples of the program instructions may include not only a machine language wire constructed by a compiler, but a high-level language wire capable of being executed by a computer using an interpreter. Such a hardware device may be configured to act as one or more software modules in order to perform an operation of the present disclosure, and vice versa.

Although the present disclosure has been described in connection with specific matters, such as the detailed components, and the limited embodiments and drawings, they have been provided only to help general understanding of the present disclosure, and the present disclosure is not limited to the embodiments. Those skilled in the art to which the present disclosure pertains may modify the embodiments in various ways from the above description.

Accordingly, the spirit of the present disclosure should not be limited and determined by the aforementioned embodiments, and all things modified equally or equivalently with the claims in addition to the claims may be said to fall within the category of the spirit of the present disclosure.

What is claimed is:

1. A method of detecting whether a robot has completed a task by considering context, the method comprising:
receiving observation information related to an execution of a robot task;
generating a prompt based on a goal related to the execution of the robot task and the received observation information;
generating a task completion detection (TCD) function based on the generated prompt; and
identifying whether the execution of the robot task is successful by using the generated TCD function.

2. The method of claim 1, further comprising:
receiving the goal and observation information related to a robot; and
predicting a task to be performed by the robot based on the goal and the observation information related to the robot,
wherein the execution of the robot task is an execution of the predicted task by the robot.

3. The method of claim 1, wherein the observation information related to the execution of the robot task comprises a sensor value detected by one or more sensors after the execution of the robot task.

4. The method of claim 1, wherein the prompt is instructions that are input to an interface of generative artificial intelligence (AI).

5. The method of claim 1, wherein the prompt comprises at least one of a system prompt comprising information related to a sensor or a user prompt comprising text generated based on the goal.

6. The method of claim 5, wherein the information related to the sensor comprises at least one of list information indicative of a list of sensors, sensor information indicative of characteristics of the sensors, mounting location information indicative of location at which the sensors are mounted, or a combination thereof.

7. The method of claim 5, wherein the user prompt further comprises information that defines an operating method of the TCD function and information that defines a function type of the TCD function.

8. The method of claim 1, wherein the generating of the TCD function comprises:
transmitting the prompt to a large language model (LLM); and
receiving the TCD function from the LLM.

9. The method of claim 8, wherein when the collected observation information comprises an image, the TCD function requests a large multi-modal model (LMM) to identify whether the execution of the robot task is successful based on the image by invoking the LLM.

10. The method of claim 1, wherein the TCD function is generated once per goal and invoked whenever the execution of the robot task is repeated.

11. A control module for detecting whether a robot has completed a task by considering context, the control module comprising:
a storage configured to store a goal related to an execution of a robot task; and
a controller configured to receive observation information related to the execution of the robot task, generate a prompt based on the goal and the received observation information, generate a task completion detection (TCD) function based on the generated prompt, and identify whether the execution of the robot task is successful by using the generated TCD function.

12. The control module of claim 11, wherein:
the storage further stores observation information related to a robot,
the controller predicts a task to be performed by the robot based on the goal and the observation information related to the robot, and
the execution of the robot task is an execution of the predicted task by the robot.

13. The control module of claim 11, wherein the observation information related to the execution of the robot task comprises a sensor value detected by one or more sensors after the execution of the robot task.

14. The control module of claim 11, wherein the prompt is instructions that are input to an interface of generative artificial intelligence (AI).

15. The control module of claim 11, wherein the prompt comprises at least one of a system prompt comprising information related to a sensor or a user prompt comprising text generated based on the goal.

16. The control module of claim 15, wherein the information related to the sensor comprises at least one of list information indicative of a list of sensors, sensor information indicative of characteristics of the sensors, mounting location information indicative of location at which the sensors are mounted, or a combination thereof.

17. The control module of claim 15, wherein the user prompt further comprises information that defines an operating method of the TCD function and information that defines a function type of the TCD function.

18. The control module of claim 11, wherein the TCD function is generated once per goal and invoked whenever the execution of the robot task is repeated.

19. A robot system for detecting whether a robot has completed a task by considering context, the robot system comprising:
a robot main body;
a sensor unit configured to generate observation information related to an execution of a robot task by the robot main body;
a storage configured to store a goal related to the execution of the robot task; and
a controller configured to generate a prompt based on the goal and the generated observation information, generate a task completion detection (TCD) function based on the generated prompt, and identify whether the execution of the robot task is successful by using the generated TCD function.

20. The robot system of claim 19, wherein:
the storage further stores observation information related to the robot main body,
the controller predicts a task to be performed by the robot main body based on the goal and the observation information related to the robot main body, and
the execution of the robot task is an execution of the predicted task by the robot main body.
